(19) United States
(12) Patent Application Publication
(10) Pub. No.: US 2014/0166154 A1
(43) Pub. Date: Jun. 19, 2014

(54) SYSTEM AND METHOD FOR REFILLING CONDIMENT BOTTLES

(71) Applicant: Christal Steen, Henrietta, NY (US)

(72) Inventor: Christal Steen, Henrietta, NY (US)

(21) Appl. No.: 13/716,609

(22) Filed: Dec. 17, 2012

(51) Int. Cl. B67D 7/02

(52) U.S. Cl. CPC B67D 7/0294
USPC 141/2; 222/505; 141/113; 222/209

(57) ABSTRACT

Condiment containers that can be refilled from the bottom are disclosed. Spouts for dispensing condiments, which have mechanisms to open and close them, are also disclosed. A method of refilling condiment containers includes the steps of connecting a spout to a bulk condiment bag and to a conduit in the bottom of a condiment container. Once the spout is connected to the bag and the condiment container, the spout is activated by moving it from a closed to an open position. When the spout is in the open position, the condiment can travel from the bulk condiment bag, through the spout, and into the condiment container. Condiment container crates and condiment container caps are also disclosed.

### BACKGROUND OF THE INVENTION

1. Field of the Invention

The invention pertains to the field of refilling condiment bottles. More particularly, the invention pertains to methods and systems for refilling condiment bottles.

2. Description of Related Art

Food service facilities such as restaurants, cafes, and fast food markets often marry condiments at some point during business hours (usually around closing time, after a shift, or after a lunch or dinner rush). “Marrying” condiments means combining two or more bottles of the condiments into one. Typically, a restaurant will purchase individual condiment containers such as glass bottles or plastic squeeze bottles, and a bulk bag or can of the condiment, which contains a large amount of the given condiment. Generally, a Vol-pak® bag (Heinz) is used to hold bulk sizes of ketchup. Heinz also manufactures Vol-pak™ bags for mustard and mayonnaise. The condiment bags are cumbersome, heavy, and difficult to maneuver. A schematic of a condiment bag 1 and its container 4 is shown in FIGS. 1a and 1b. The bag 1 holds three gallons of the condiment, and also includes a hole fitted with a plastic threaded spout 2 that is capped 3 after manufacturing. To facilitate handling, the condiment bag 1 is placed within a container (typically a cardboard box) 4, and the spout 2 is extended through the container 4 so that the condiment can be dispensed out of the bag 1 through the hole.

Many restaurants rely on the Vol-Pak™ valve to refill their condiment containers. This valve attaches to an available dispensing unit, such as the bag 1 shown in FIG. 1a, to dispense the condiments from the Vol-Pak® bag. Once the cap 3 is removed by the end user, a Vol-Pak™ valve is typically placed on the bag 1 and the cap 3 is discarded. A schematic of a Vol-Pak™ valve 10 is shown in FIGS. 1c through 1h. The valve 10 preferably includes two cylindrical portions 13 and 215. The first cylindrical portion 13 is interiorly lined with a flexible plastic portion 17, as well as a rigid plastic portion or pin 19. The rigid plastic portion 19 is connected to the flexible plastic portion 17 and the push bar 12. The second cylindrical portion 215 has an end section 18 that fits into an interior of the spout 2 of the condiment bag 1. Also at the end of the second cylindrical portion is a threaded locking ring 14 which screws into the outer threads 16 of the spout 2.

In a first position, the flexible plastic portion 17 in the first cylindrical portion 13 blocks flow of the condiment from the second cylindrical portion 215 into a condiment container, as shown in FIG. 1g. When the push bar is activated, the rigid plastic portion 19 and the flexible plastic portion 17 to which it is attached move from one side of the cylindrical portion 13 to the other side of the cylindrical portion 13, exposing the interior 220 of the second cylindrical portion 215 and permitting the condiment to flow through the valve 10 and into a condiment container, as shown in FIG. 1f.

When the user wishes to dispense the condiment, he pushes the push bar 12, which opens up flow from the condiment bag 1 through the valve 10. The valve 10 is preferably placed in the vicinity of the top of a condiment container (preferably a few inches above the condiment container), so that the condiment is dispensed into the container. The Vol-Pak™ valves 10 are often difficult to use, since the push bar 12 requires a lot of pressure. The valves 10 are also difficult to clean. While there are coupler kits available to couple the Vol-pak™ bags to manual and automatic systems, these couplers do not address the problems of individually marrying condiment bottles.

The process of marrying condiments is a tedious and often avoided task. It can become very wasteful and is quite time consuming Often times, this task is done improperly by employees due to the level of difficulty and time it takes.

One example of the typical process for marrying condiments begins with gathering all of the condiment containers together. For the example of ketchup, the waitstaff or other employees in a restaurant typically gather all of the ketchup bottles together onto a single table. The caps are then taken off of all of the bottles. These caps are then placed in hot water to clean them.

The ketchup bottles are then separated into two groups: bottles that are fuller (e.g.—more than half full) and bottles that are less full (e.g.—less than half full). The bottles that are less full will be “married” into the ones that are fuller. This means that the ketchup from the bottles that are less full will be poured into the fuller bottles. It may take ketchup from three or more bottles to fill a bottle to its desired amount.

In establishments that reuse the bottles, the empty bottles are sanitized and rinsed. In other establishments, the empty bottles may be placed in recycling bins, or even thrown away.

The ketchup bag or a bulk size can of ketchup is then used to refill empty sanitized bottles and may also be used to top off bottles that are not yet completely full. The ketchup from the ketchup bag is placed into the ketchup bottle from the top of the bottle. The now-filled ketchup bottles are then wiped down, paying special attention to the cap threads. The caps are removed from the water, rinsed, and dried. The bottles are then all recapped and placed in storage for use the next business day.

When the task of marrying condiments is done incorrectly, it may create unnecessary waste. Even though the bottles are reused, their contents may not be getting proper attention. Often times, fresh condiments are placed on top of old condiments, causing them to expire at a greater rate. If the end of the condiment supply never sees rotation, it will begin to turn rancid. Tiny air bubbles, which can usually be seen near the base of the container and indicate the condiment container was never properly married, in large groups will appear and the entire contents must be disposed of. In some cases, the container must be disposed of as well. It is never clear how old the condiment in a particular bottle is, since the marrying process continually adds new condiment to the top of the bottle, and the oldest condiment remains in the bottle, sometimes indefinitely.

Currently facilities, such as restaurants, have the option to purchase accessories, or savers, which assist employees in performing the tedious task of marrying condiments. There are currently approximately half a dozen items on the market that are designed to assist users. They are available in a variety of shapes and sizes and also vary in cost. Conceptually, these savers are all the same. They allow employees to continue with other tasks while the saver does the work. However, these savers still compromise the condiments. While they do assist food facilities, they do not ensure that condiment containers go through the proper marrying process.

FIGS. 2a and 2b show one example of a saver 20 as known in the prior art. The saver 20 is basically a two-sided connector with an hourglass shape. The saver 20 includes two wider portions 21, which fit onto the tops of the condiment containers 22. The condiment passes by gravity from a first condiment container 22 through one of the wider portions 21, a narrower portion 23, then through the other wider portion 21, before entering a second condiment container 22. An extension 24 preferably extends out of the center of the saver 20 on one side of the saver 20. The extension 24 preferably includes a hole 25 that creates air in the ketchup being dispensed from the upper container 22 into the lower container 22.

FIG. 3 shows another example of a saver 30 as known in the prior art. The saver 30 includes a main bucket section 31, with spaces 33 for up to six condiment containers 32. The condiment containers 32 empty into the bottom of the main bucket section 31, where they pass through a delivery section 34 into a single condiment container 35 to fill that container 35. The saver 30 also includes legs 36 to hold the saver 30 in place over the condiment container 35 during use. This saver 30 has the added disadvantage of marrying multiple condiment containers 32 into one condiment container 35, when it is completely unknown the age of the condiments in each of the containers.

FIG. 4 shows yet another example of a saver 40 as known in the prior art. The saver 40 includes a main frame 41. The top of the frame includes holes 43 in which to place up to three top condiment containers 42. The frame 41 also includes a hollow interior 44 in which up to three bottom condiment containers 45 may be placed. The top condiment containers 42 are tilted and lined up with the bottom condiment containers 45 to transfer the condiment from the top condiment containers 42 to the bottom condiment containers 45.

FIG. 5 shows another example of a saver 50 as taught in U.S. Pat. No. 4,207,933. The saver 50 includes a top portion 51 with holes 53 into which three condiment containers 52 can be placed top down. The condiment in the condiment containers 52 is transferred through a funnel 54 sitting in a base in the middle of the saver 50. The funnel 54 transfers the condiment into another condiment container 55 through the bottom tip 56 of the funnel 54. The condiment container 55 sits on a bottom base 57 of the saver 50.

As shown in FIGS. 2 through 5, all of the savers replenish condiment containers from the top of the bottle, and do not address the problems of the condiment in the bottom of the containers never being rotated or used. Many of the savers also combine condiment from multiple bottles into a single bottle, increasing the likelihood of older condiment being mixed with newer condiment.

In order to avoid the problems and time involved in marrying condiments, some restaurants may choose to use disposable containers, and throw them away after only one use, which is extremely wasteful.

There is a need in the art for a better, more efficient and cost-effective system for marrying condiments.

### SUMMARY OF THE INVENTION

Condiment containers that can be refilled from the bottom are disclosed. Spouts for dispensing condiments, which have mechanisms to open and close them, are also disclosed. A method of refilling condiment containers includes the steps of connecting a spout to a bulk condiment bag and to a conduit in the bottom of a condiment container. Once the spout is connected to the bag and the condiment container, the spout is activated by moving it from a closed to an open position. When the spout is in the open position, the condiment can travel from the bulk condiment bag, through the spout, and into the condiment container. Condiment container crates and condiment container caps are also disclosed.

### BRIEF DESCRIPTION OF THE DRAWINGS

FIG. 1a shows a bulk condiment bag for holding condiments as known in the prior art.

FIG. 1b shows the container for the bulk condiment bag of FIG. 1a, as known in the prior art.

FIG. 1c shows the exterior of a valve that connects to the bulk condiment bag for dispensing, as known in the prior art.

FIG. 1d shows an interior view from the bottom of the valve in FIG. 1c when the valve is closed.

FIG. 1e shows another interior view from the bottom of the valve when the valve is closed.

FIG. 1f shows an interior view from the bottom of the valve in FIG. 1c when the valve is open.

FIG. 1g shows a top down side view of the valve of FIG. 1c.

FIG. 1h shows a valve being screwed to a condiment bag as known in the prior art.

FIG. 2a shows an example of a condiment saver as known in the prior art being used to marry two condiment bottles.

FIG. 2b shows the condiment saver of FIG. 2a.

FIG. 3 shows another example of a condiment saver as known in the prior art.

FIG. 4 shows another example of a condiment saver as known in the prior art.

FIG. 5 shows another example of a condiment saver as known in the prior art.

FIG. 6a shows one embodiment of a condiment container of the present invention with the outer disk-shaped portion (the cap) removed.

FIG. 6b shows a bottom up view of the bottom of the condiment container of FIG. 6a.

FIG. 6c shows a cross-sectional view of FIG. 6b along lines 6c-6c.

FIG. 6d shows the embodiment of FIG. 6a with the outer disk-shaped portion on the bottom of the container.

FIG. 6e shows an embodiment of a plug.

FIG. 6f shows another embodiment of a plug.

FIG. 6g shows an embodiment of the cap of the plug.

FIG. 7a shows an exploded view of a plug mechanism.

FIG. 7b shows a view of the bottom of the condiment container of FIG. 7a with the tamper-proof cap.

FIG. 7c shows a magnetic quarter turn key that fits into the keyhole on the cap of the dispensing system shown in FIGS. 7a and 7b.

FIG. 7d shows a side view of the key of FIG. 7c.

FIG. 8a shows a cross-sectional view of a condiment container including a plug in an embodiment of the present invention.

FIG. 8b shows a bottom view of the condiment container of FIG. 8a with a tamper-proof magnetic cap in place.

FIG. 8c shows a bottom view of the top of the tamper-proof cap.

FIG. 8d shows a side view of the tamper-proof magnetic cap.

FIG. 8e shows a side view of the conduit.

FIG. 8f shows a view of the conduit when looking at the plug mechanism from the inside top of the bottle.

FIG. 8g shows a view of the diaphragm when looking at the plug from the bottom of the bottle.

FIG. 8h shows a side view of the diaphragm.

FIG. 8i shows an alternative key for use with the plug mechanisms of the present invention.

FIG. 9a shows a view of a spout in an embodiment of the present invention, in the closed position.

FIG. 9b shows a view of the spout of FIG. 9a in an open position.

FIG. 10a shows a flowchart of a method of marrying condiments in an embodiment of the present invention.

FIG. 10b shows a flowchart of a method of marrying condiments in an embodiment of the present invention.

FIG. 11a shows a top view of a crate for holding condiment containers in an embodiment of the present invention.

FIG. 11b shows a side view of the crate of FIG. 11a.

FIG. 12 shows a cap with a protrusion in an embodiment of the present invention.

FIG. 13 shows a wall mount for a condiment dispenser in an embodiment of the present invention.

FIG. 14a shows a condiment container with a stopper in an embodiment of the present invention.

FIG. 14b shows the stopper of FIG. 14a.

Note that the drawings are not drawn to scale.

### DETAILED DESCRIPTION OF THE INVENTION

The embodiments discussed herein relate to apparatus and methods used for the combination of moderate flowing materials such as viscous condiments including, but not limited to, ketchup, mustard, mayonnaise, barbecue sauce, steak sauce, and hot sauce. Various connectors and dispensers are disclosed in which the contents of the condiment containers are combined and dispensed. These embodiments encourage those working in the restaurant industry to be more conscientious in maintaining the freshest condiment possible. The embodiments are also more sanitary, less wasteful, support the idea of reusing and reducing materials, and are environmentally safe. The present invention helps restaurants reduce pollution waste and save money.

In the methods disclosed herein, condiments are never transferred from one container to another container through the top of the container receiving the condiment. This eliminates the problems with old condiment remaining forever in the bottom of a bottle of a condiment container, leading to spoilage and waste.

Condiment containers disclosed herein include a main body and a plug. The bottoms of the condiment containers are designed such that new condiment can be transferred into each condiment container from the bottom of the container. This greatly reduces the likelihood that the condiment will go rancid, since the newest condiment is always being added at the bottom of the bottle. In preferred embodiments, glass condiment containers are used to promote extended reuse of the containers, and reduce waste. Glass is recyclable, durable, and affordable. In other embodiments, food grade plastics, including but not limited to, polypropylene, polycarbonate, low density polyethylene, or PLA resin based plastics (corn plastics) could be used. The condiment containers are also preferably clear or light in color; however, any color could be used for the condiment containers.

Each embodiment of condiment containers of the present invention includes an accessible conduit at the bottom of the condiment container, in order to dispense new condiment into the container from the bottom of the container. In one preferred embodiment, the base of the container preferably has a hole in the center. A preferably tamper-proof dispensing system lies in the hole. In preferred embodiments, the dispensing system includes a cap, a conduit, a key hole for a key such as a magnetic quarter-turn key, a diaphragm/seal, and, in some embodiments, an inverted tip. Other specific embodiments for the base are also discussed herein.

The present invention also includes embodiments for spouts that connect the condiment containers to a bulk condiment bag, or another source of the condiment. The spouts are designed to be easier to use than the condiment valve known in the prior art. In one preferred embodiment, the spout is round with a nozzle congruent to an inverted tip but longer in length. Near the base of the nozzle, a separate tube is preferably attached to the side. This tube, which is an air release tube, is shorter in length than the nozzle at the base and preferably curves outward near the top.

The front of the spout preferably features a push lever or another activation mechanism, such as a push button or a squeeze ball. The lever has a larger surface area for pushing on than the prior art valve, making it easier to press and use. The lever is held in place with a long pin. The pin is preferably encased in a spring and attached to a release door. The connecting end of the spout attaches to the threaded spout of the bulk condiment bag with a rotational locking ring. In preferred embodiments, a magnetic tipped key preferably hangs around the neck of the spout, which opens the bottom of a condiment container that includes a conduit and a tamper-proof cap that can be removed using the magnetic quarter-turn key. When the cap of the dispensing system is removed by the magnetic tipped key, the cap preferably remains magnetically attached to the key until the cap is removed from the key or the cap is returned to the dispensing system on the container upon which it is being used.

The present invention encourages filling only one bottle at a time, while making it easier to do so. In this manner, not as much condiment is wasted and spoilage is prevented.

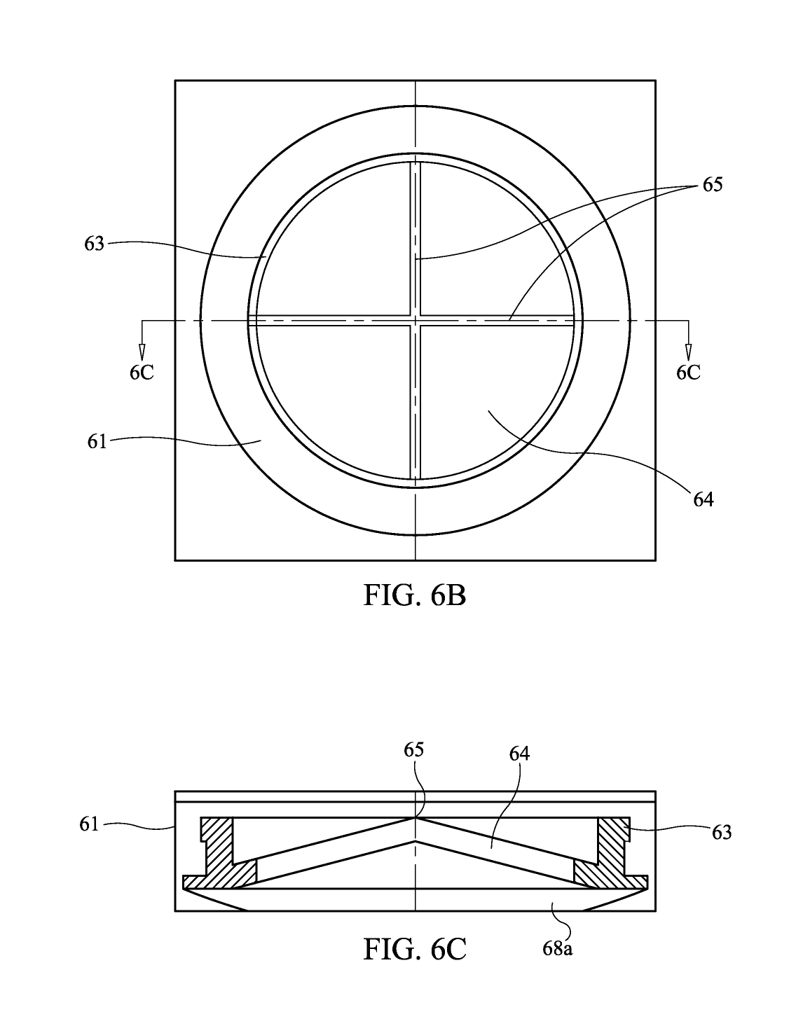

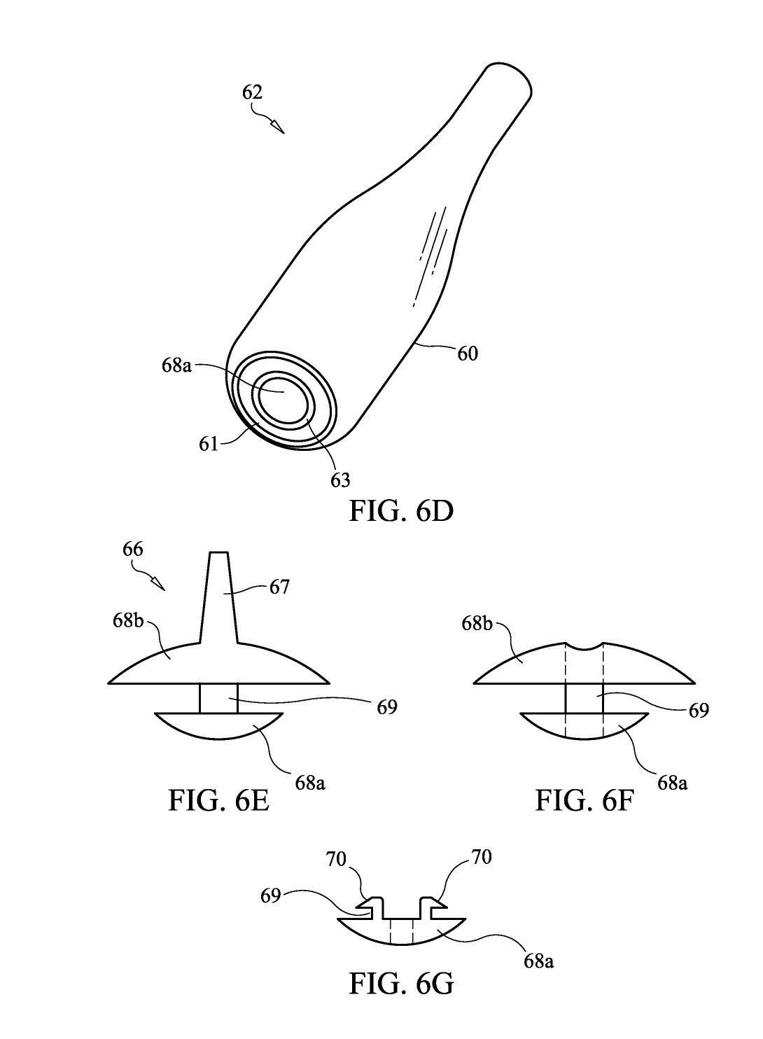

A simple embodiment of a condiment container 62 with an entry point for the condiment at its base is shown in FIGS. 6a through 6g. The condiment container 62 preferably includes a main body 60, which is made of glass or plastic. The bottom 61 of the condiment container 62 includes a base 63, which has been inserted into the bottom 61 of the condiment bottle 62 or manufactured integrally with the condiment container 62. The base 63 is preferably disk-shaped to match the shape of the bottom 61 of the condiment container 62. However, the base 63 could be of different shapes, as long as the base 63 fits within the bottom 61 of the condiment container 62. Similarly, if the bottom 61 of the condiment container 62 is a different shape, such as a square or a rectangle, the base 63 is alternatively the same shape as the bottom 61 of the condiment container 62 or the base 63 is disk or oval-shaped to fit into the bottom 61 of the condiment container 62. The base is preferably made of a malleable material, such as bendable plastic, which reacts when pressure is applied.

The base 63 preferably includes a transfer portion 64 that will allow insertion of a spout or other transfer mechanism into the condiment container 62, but prevents leakage during regular use of the condiment container 62. In this embodiment, the transfer portion 64 is essentially two slits 65 shaped like an X, which create an opening in the condiment container 62 when a nozzle puts pressure on the slits 65. The X-shaped slits 65 are small enough to prevent leakage of the condiment out of the condiment container 62 when the condiment container 62 is upright and in use. In some preferred embodiments, the slits are also bent slightly upwards towards the top of the condiment container 62, which further prevents leakage out of the container 62 when it is in its upright position. This allows insertion of a condiment into the bottom 61 of the condiment container 62. The slits 65 also act to clean the spout dispensing the condiment as the spout is removed from the condiment container. While two slits are shown in the figure, other embodiments where a hole is created upon insertion of a nozzle are within the spirit of the present invention. The base 63 may also optionally include a cap or flip-top lid (outer disk-shaped portion 68a), which covers the transfer portion 64 when not in use and exposes the transfer portion 64 when someone wants to refill the condiment container.

While the outer disk-shaped portion 68a can be seen from outside the condiment container 62 when inserted in the condiment container 62, the rest of the plug 66 on the base 63 includes an inner disk-shaped portion 68b, a thin portion 69 connecting the outer disk-shaped portion 68a and the inner disk-shaped portion 68b, and a nozzle section 67 that extends into the interior of the condiment container 62. The transfer portion 64 permits transfer of the condiment into the condiment container 62 through the nozzle section 67.

FIG. 6e shows one embodiment of a plug 66. The plug includes two disk-shaped portions 68a and 68b, with a thinner portion 69 that connects the two disk-shaped portions 68a and 68b. The disk-shaped portions are contoured to match the shape of the bottom of the container, to increase the seal. This embodiment also includes a nozzle section 67 that extends into the interior of the condiment container 62. The outer disk-shaped portion 68a is outside the container, while the inner disk-shaped portion 68b is inside the container. The condiment travels through the transfer portion 64 (see, e.g. FIGS. 6a-6c) in the outer disk-shaped portion 68a, through the thinner portion 69, the inner disk-shaped portion 68b and the nozzle section, 67, into the condiment container 62. Since the base is made of a malleable material, such as plastic, the base can be pinched to place the inner disk-shaped portion 68b and the thinner connector portion 69 inside the condiment container for use. Once the inner disk-shaped portion 68b and the thinner connector portion 69 are inside the container, the plug clamps and creates a seal. The materials used to make the plug are preferably durable, easy to replace, and leak proof. In preferred embodiments, the plug is made of a malleable material, such as bendable plastic, which reacts when pressure is applied. These pieces could be sold in bulk. The transfer portion 64 is preferably similar to the transfer portion discussed with respect to FIGS. 6a through 6c. The entire plug shown in FIG. 6e is preferably made as a single piece.

In another preferred embodiment, two pieces that snap together could be used to manufacture the plug. For example, the two disk-shaped portions 68a and 68b could be manufactured as two separate pieces (with either of the pieces including the thinner portion 69) that can be snapped together to form the plug. For example, FIG. 6g shows the outer disk-shaped portion 68a, the thinner middle portion 69 and fins 70 that connect and lock into an inner disk-shaped portion 68b (shown in FIGS. 6e and 6f).

FIG. 6f shows an alternative embodiment of the base shown in FIGS. 6a through 6c. This embodiment is similar to FIG. 6e, but does not include a nozzle section 67. Instead, there are only outer 68a and interior disk-shaped portions 68b and a middle section 69 that connects them. A hole in the middle section 69 extends into the interior disk-shaped portion, and dispenses the condiment into the condiment container.

While FIGS. 6a through 6g are described with respect to round and disk-shaped holes in the condiment container, any other shape for the plug and the hole in which the plug fits could alternatively be used.

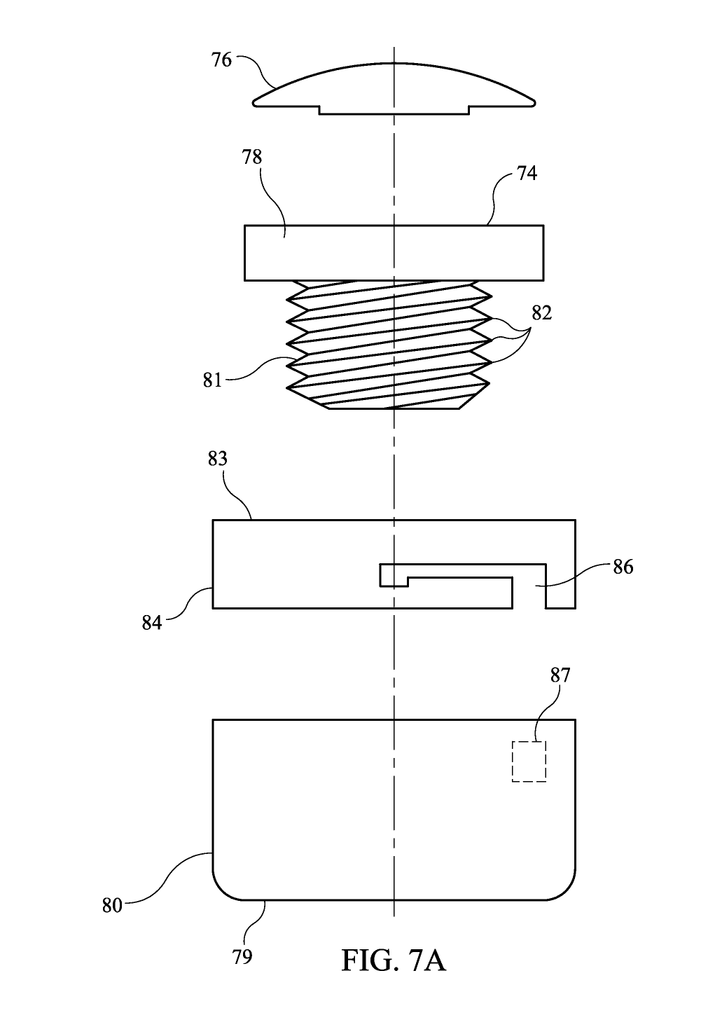

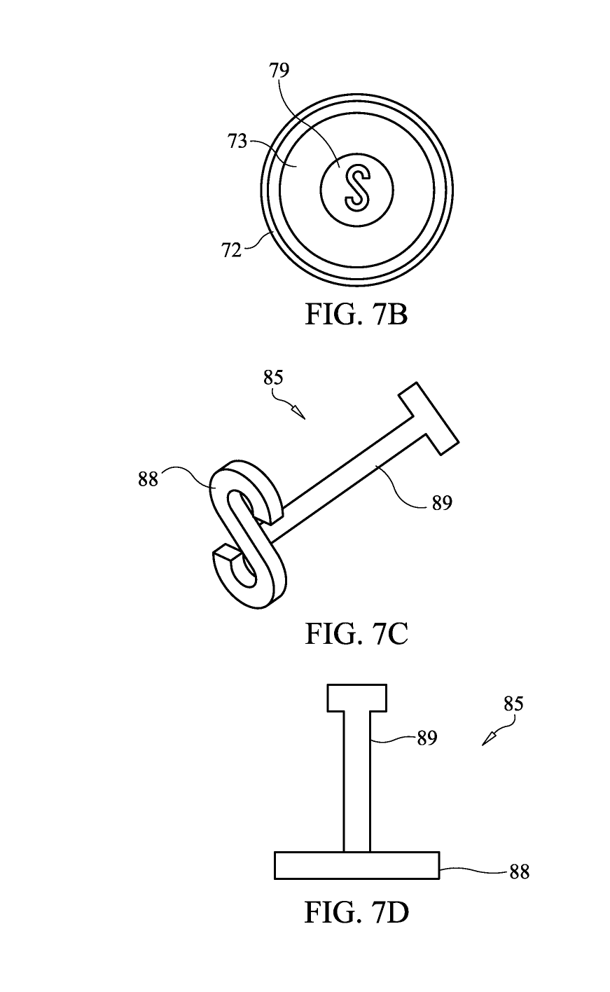

In another embodiment of the condiment containers of the present invention shown in FIGS. 7a through 7d, the bottom of a condiment container 72 includes a base 73. A conduit 74 is inserted through a hole in the base 73. The conduit is preferably made of a material that can include threads, for example a metal such as aluminum. An inserted seal or diaphragm 76, preferably with a four way split or another puncture/hole for entry of the condiment into the bottle (for example, the four way split similar to the four way split shown in FIG. 6a), seals the bottom of the container from leakage or tampering. The diaphragm 76 fits over the base portion 78 of the conduit 74. The diaphragm 76 is preferably made of a soft resin plastic or another material that is malleable. The conduit 74 includes a base portion 78 and a threaded portion 81. Threads 82 on the exterior of the threaded portion 81 of the conduit 74 mate with threads 83 on an interior portion of a threaded bushing 84. The exterior of the bushing 84 contains a reservoir 86 with a mechanism for locking a tamper-proof cap 80 on the plug. In the embodiment shown in FIG. 7a, the reservoir 86 is a notch that mates with a notch 87 on the tamper-proof cap 80.

In a preferred embodiment, the diaphragm 76 and the base portion 78 of the conduit 74 are within the condiment container 72. The threaded portion 81 of the conduit 74 extends out of the condiment container 72, and the bushing 84 and the cap 80 are outside the condiment container 72 when the plug is in use.

In one preferred embodiment, the diaphragm 76 includes a 4 way split in the middle, and is approximately ¼ to ½ inches thick. In another preferred embodiment, the base portion 78 of the conduit 74 is approximately ¼ inch thick. In another preferred embodiment, the entire conduit 74 (the base 78 and the threaded 81) is approximately 1½ inches thick. In another preferred embodiment, the threaded bushing 84 is approximately ½ inches thick. In another preferred embodiment, the tamper-proof magnetic cap 80 is approximately ¾ inches thick and include three notches 87 inside that fit into three reservoirs 86 (preferably approximately equal distances apart from each other) of the bushing 84. Preferred embodiments include a combination of all of these preferred dimensions. Other preferred embodiments include any combination of any of these dimensions.

The cap 80 (the top 79 of the cap 80 is shown in FIG. 7a, and includes a keyhole, which is shown as S-shaped in FIG. 7b) is outside the condiment container and fits into the reservoir 86 of the bushing 84. In one preferred embodiment, the keyhole in the top 79 of the cap 80 preferably fits a magnetic quarter-turn key 85 with the same shape as the keyhole, for example the key 85 shown in FIGS. 7c and 7d. The magnetic quarter-turn key 85 includes a locking section 88, shaped like an S in the example shown in FIGS. 7b through 7d. The key 85 also includes a handle section 89. In preferred embodiments, the magnetic quarter-turn key could hang from a spout (for example, using a spout described in the spout embodiments below, or the prior art Vol-pak™ valve) used to dispense the condiment into the condiment container. In these embodiments, the key 85 would be readily available whenever someone wanted to refill a condiment container. In other embodiments, the magnetic turn key 85 could be placed on any magnetic surface, for example attached to a refrigerator or a metal table in a restaurant kitchen, and retrieved when needed. Note that the magnetic key shown in FIGS. 7c and 7d could be used in any of the embodiments discussed herein.

In other embodiments, instead of the cap 80 being unlocked and opened with a key 85, the cap 80 could include a notch at the top 79 of the cap, into which a coin or another thin implement could be placed to remove the cap 80 from the base 73. The coin or thin implement could be attached or hung from the spout, similarly to the quarter-turn key embodiments discussed above. Alternatively, since coins are so widely available, it is likely that the restaurant staff would have one on hand whenever they needed it.

In still other embodiments, the cap 80 could include a keyhole that uses a standard key to unlock or open the lock. Since restaurants would have multiple condiment containers, and may be rotating them nightly, in embodiments with a key that fits into the cap 80, a master or skeleton key would preferably fit all of the caps 80 in all of the condiment containers. The master key could be attached or hung from the spout, similarly to the quarter-turn key embodiments discussed above. Alternatively, each member of the restaurant staff could have a master/skeleton key, so that each would be able to refill the condiment containers as needed.

The locking mechanism forms a tamper-proof dispensing system. When turned a quarter turn using a quarter-turn magnetic key 85, the cap 80 can now be removed. Since the key 85 and the cap 80 are both magnetic, the cap 80 is retained on the magnetic key 85 until reinsertion into the bushing 84 of the condiment container. Without the cap 80, the diaphragm no longer forms a seal, and a spout or nozzle can be placed in the condiment container to fill the container.

When the key 85 is turned, it removes the cap 80, exposing the bushing 84, the diaphragm 76 and the conduit 74. Insertion of a nozzle from a spout punctures the diaphragm 76, breaking the seal and opening up the condiment container to receive additional condiment.

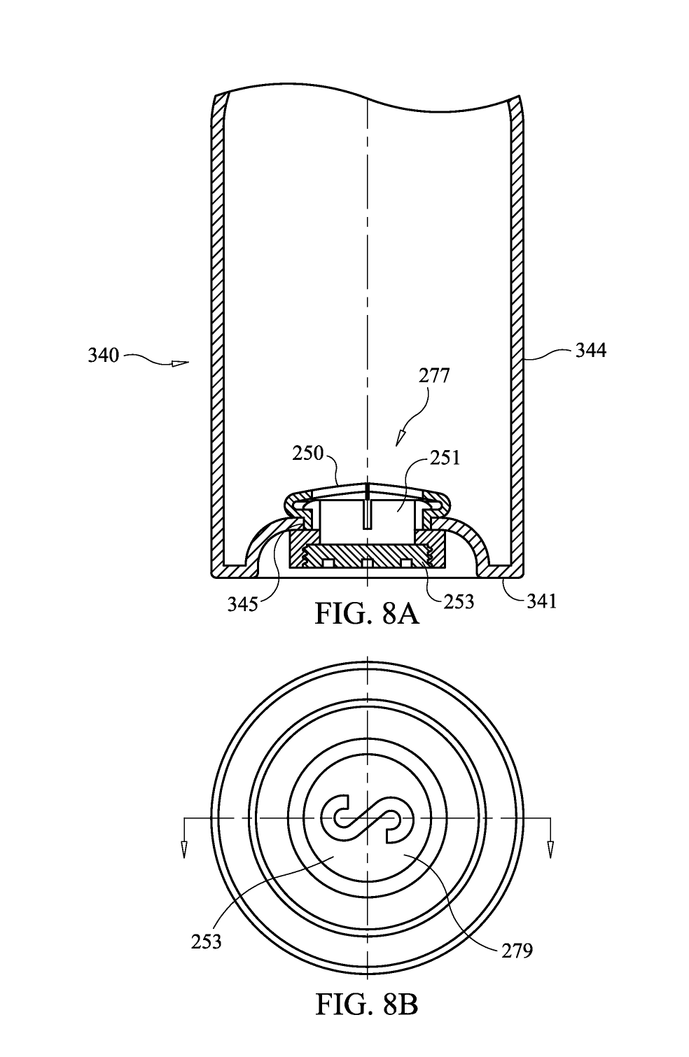

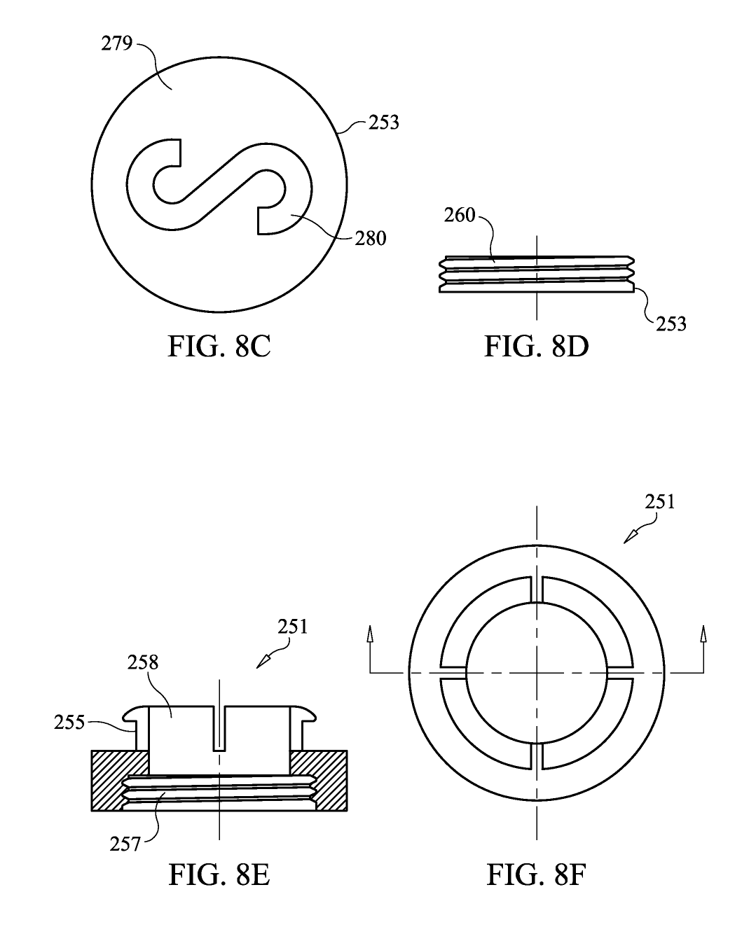

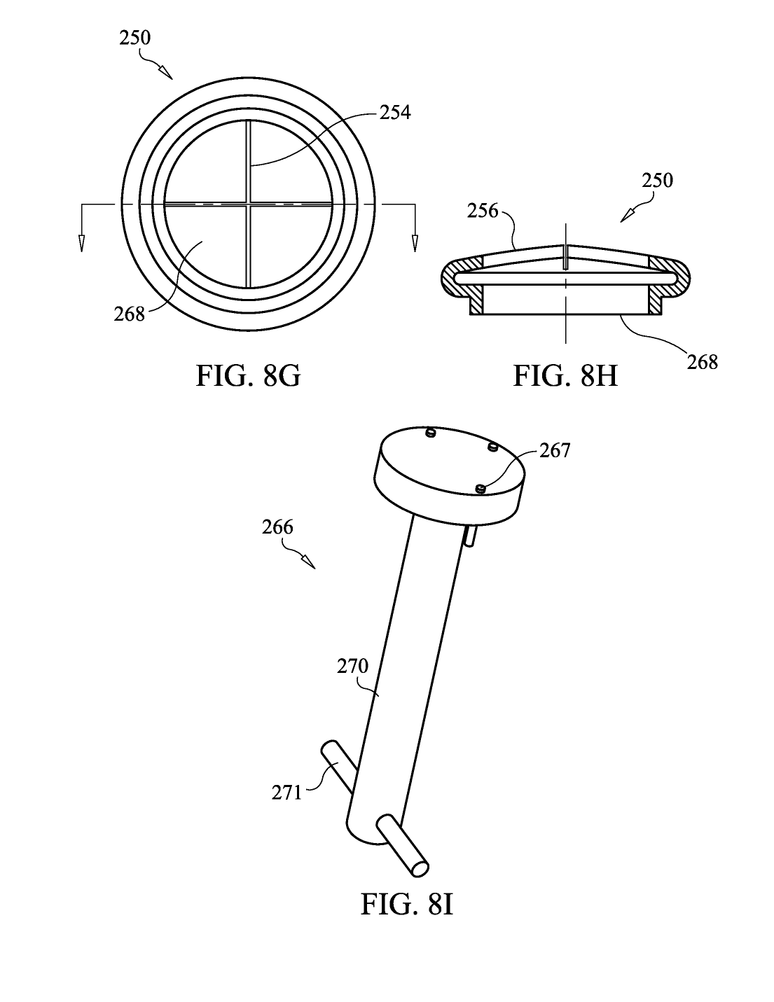

FIGS. 8a through 8h show another embodiment of a condiment container 340 having a refilling mechanism in the bottom 341 of the condiment container 340. The main body 344 of the condiment container 340 is preferably manufactured as a single piece with an opening 345 in the bottom 341 of the condiment container 340. Although not preferred, in other embodiments, the bottom 341 of the condiment container 340 may be manufactured as a separate piece from the main body 344, and attached after manufacture.

As shown FIG. 8a, the plug mechanism in this embodiment includes a diaphragm 250, a conduit 251, and a cap 253. These three pieces 250, 251, 253, fit together to form the plug mechanism 277 in an opening in the bottom of the condiment container 340. As in previous embodiments, the diaphragm 250 is preferably malleable and is made of food grade rubber or plastic material. Because it is malleable, the diaphragm can be easily pushed through the top of the condiment container 340 in order to place the diaphragm 250 in position for the plug mechanism. In preferred embodiments, when the plug mechanism is in place in the condiment container 340, the conduit 251 is either flush with the very bottom of the condiment container 340, or slightly recessed. The diameter of the opening 345 is sized to fit the main body 258 of the conduit 251.

The diaphragm 250 preferably includes a donut portion 256 that forms a seal in the interior of the condiment container 340. The donut portion 256 of the diaphragm faces towards the top of the condiment container 340 when the diaphragm 250 is placed in the condiment container 340. The diaphragm 250 also includes a bottom section 268 with slits 254 so that the shoulder 255 of the conduit 251 can be pushed into the interior of the diaphragm 250, while the main body 258 of the conduit 251 extends towards the exterior of the condiment container.

The main body 258 of the conduit 251 includes interior threads 257 to mate with exterior threads 260 of the cap 253. The main body 258 of the conduit has a diameter sized so that the cap 253 fits snugly in the conduit 251 when the exterior threads 260 of the cap 253 mate with the interior threads 257 of the conduit 251.

In one preferred embodiment, the key mechanism discussed with respect to FIGS. 7c through 7d can be used with the plug mechanism 277 described in FIGS. 8a through 8h. More specifically, the magnetic quarter-turn key 85 includes a locking section 88, shaped like an S in the example shown in FIGS. 7d through 7d. The key 85 also includes a handle section 89. The key 85 fits into a keyhole 280 in the cap 253. In preferred embodiments, the magnetic quarter-turn key could hang from a spout (for example, using a spout described in the spout embodiments below, or the prior art Vol-pak™ valve) used to dispense the condiment into the condiment container. In these embodiments, the key 85 would be readily available whenever someone wanted to refill a condiment container. In other embodiments, the magnetic turn key 85 could be placed on any magnetic surface, for example attached to a refrigerator or a metal table in a restaurant kitchen, and retrieved when needed.

In other embodiments, instead of the cap 253 being unlocked and opened with a key 85, the cap 253 could include a notch at the top 279 of the cap 253, into which a coin or another thin implement could be placed to remove the cap 253 from the conduit 251. The coin or thin implement could be attached or hung from the spout, similarly to the quarter-turn key embodiments discussed above. Alternatively, since coins are so widely available, it is likely that the restaurant staff would have one on hand whenever they needed it.

In still other embodiments, the cap 253 could include a keyhole that uses a standard key to unlock or open the lock. Since restaurants would have multiple condiment containers, and may be rotating them nightly, in embodiments with a key that fits into the cap 253, a master or skeleton key would preferably fit all of the caps 253 in all of the condiment containers. The master key could be attached or hung from the spout, similarly to the quarter-turn key embodiments discussed above. Alternatively, each member of the restaurant staff could have a master/skeleton key, so that each would be able to refill the condiment containers as needed.

The locking mechanism forms a tamper-proof dispensing system. When turned a quarter turn using a quarter-turn magnetic key 85, the cap 253 can now be removed. Since the key 85 and the cap 253 are both magnetic, the cap 80 is retained on the magnetic key 85 until reinsertion into the conduit 251 of the condiment container. Without the cap 253, the diaphragm no longer forms a seal, and a spout or nozzle can be placed in the condiment container to fill the container.

When the key 85 is turned, it removes the cap 253, exposing the conduit 251 and the diaphragm 250. Insertion of a nozzle from a spout punctures the diaphragm 250, breaking the seal and opening up the condiment container to receive additional condiment.

In another embodiment, the cap 253 also includes three holes on the outer portion of the cap 253. The three holes mate with protrusions or pins 267 on a key 266, shown in FIG. 8i. This configuration makes the key mechanism tamper-proof. In preferred embodiments, the three holes and the pins 267 are magnetic. When the holes and the key 266 are magnetic, the magnetic turnkey 266 is interlocked with the cap 253, and turned to remove the cap 253, for example a ¼ turn. In this embodiment, since the key 266 is magnetic, the cap 253 and the key 266 would remain together during the refilling process. The key 266 also preferably includes a handle 270 and may optionally also include one or more grips 271 to make it easier to turn the key 266 and remove the cap 253.

While three holes and corresponding pins 267 are discussed with respect to FIG. 8i, less or additional holes or other shapes (for example, the S shape discussed herein) and a corresponding shape or holes on the key 266 may be used for the key 266 and cap 253 interaction. The pins 267 and holes may also be of any length that permits good interaction between the two elements.

To refill the condiment container 340, the condiment container is preferably turned upside down and placed on a surface (for example in the crate discussed below) to stabilize it. The keyhole 280 in the cap 253 mates with the key 85, 266. Once they have mated, the cap 253 can be turned and removed from the rest of the plug mechanism. Once removed, there is an entryway formed between the conduit 251 and the diaphragm 250, so that the condiment container can be refilled with the condiment. The slits 254 in the diaphragm 250 permit entry of condiment into the condiment container 340, but prohibit the condiment from exiting the container 340 out the bottom. The diaphragm 250 creates a seal to keep the condiment in the condiment container 340. When the condiment container has been filled, the cap can be returned to the bottom of the condiment container 340, and screwed back into place using the key 85, 266.

In one preferred embodiment, a seed is embedded into the material of the diaphragm when the diaphragm is manufactured. In this embodiment, the diaphragm is preferably made of a biodegradable material that can be placed in the ground to plant the seed when the diaphragm is worn and no longer of use in the plug mechanism. The seed can be a seed of any type of plant.

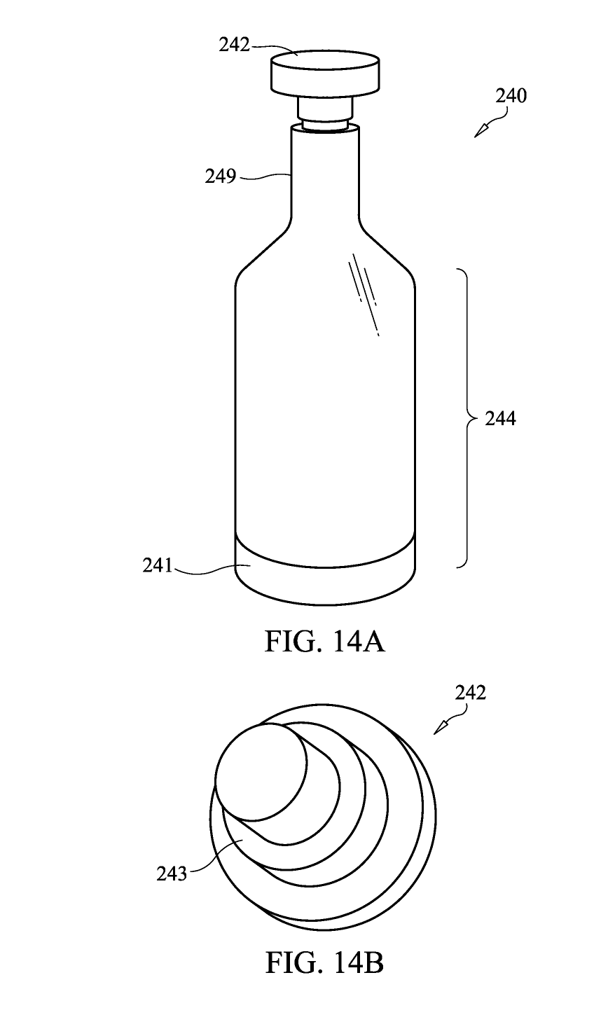

A condiment container 240 shown in FIGS. 14a and 14b preferably includes a main body 244, a neck 249, and a stopper 242 that snugly fits within the top of the condiment container 240. The stopper 242 preferably includes a plastic portion 243 that creates a seal between the condiment container 240 and the stopper 242 when the stopper 242 is placed on the condiment container 240. The plastic portion 243 is preferably removable and easily washed. Neither the stopper 242 nor the neck 249 of the condiment container 240 in this embodiment contains threads. Instead, the stopper 242 and the neck 249 both taper for a secure fit. In alternative embodiments, however, a threaded neck and top could be used.

Although the condiment container 240 is shown with a particularly designed stopper 242 in FIGS. 14a and 14b, any condiment container 240 cap or lid could be used. The bottom 241 of the condiment container 240 is preferably thick enough so that it can sustain the plug mechanism described and shown in FIGS. 6, 7, and 8. Similar condiment containers 240 may be used in other embodiments of the invention. The condiment container 240 and stopper 242 are preferably made of glass, but it may alternatively be made of food grade plastic or other food grade materials.

While the plugs in the condiment containers are discussed with reference to specific embodiments for the plug mechanism, other mechanisms are also within the spirit of the invention. For example, in one alternative embodiment, the plug mechanism could be a screw-type mechanism, where the conduit in the condiment container includes threads that mate with a threaded screw. Screwing the plug onto the bottom of the container closes and seals the container. The plug can be easily unscrewed and a nozzle of a spout can be inserted to dispense the condiment into the bottom of the container.

The conduit and the other components of the plug in the condiment containers may be made of any food-grade material that is durable enough to sustain continued and repeated use. Some examples include, but are not limited to, aluminum, polylactide, other known plastics, magnetic materials, or soft rubber.

The entire mechanism can be placed on a bottle manufactured with a hole in the bottom of the bottle. Since glass bottles are typically made with a front plate and a back plate, it would be relatively simple to manufacture the bottle halves to create a hole in the bottom of each bottle. The condiment containers of the present invention are preferably manufactured with a hole in the center for insertion of the conduit. In preferred embodiments, the conduit may be manufactured integrally during the manufacture of glass condiment containers.

The present invention also includes embodiments for spouts and nozzles that can manually transfer condiments from large industrial size bags (such as Vol-pak™ bags) into condiment containers.

The existing valve 10 for dispensing condiments from a large bulk bag 1 is difficult to clean, as well as being difficult for some people to push and commence dispensing.

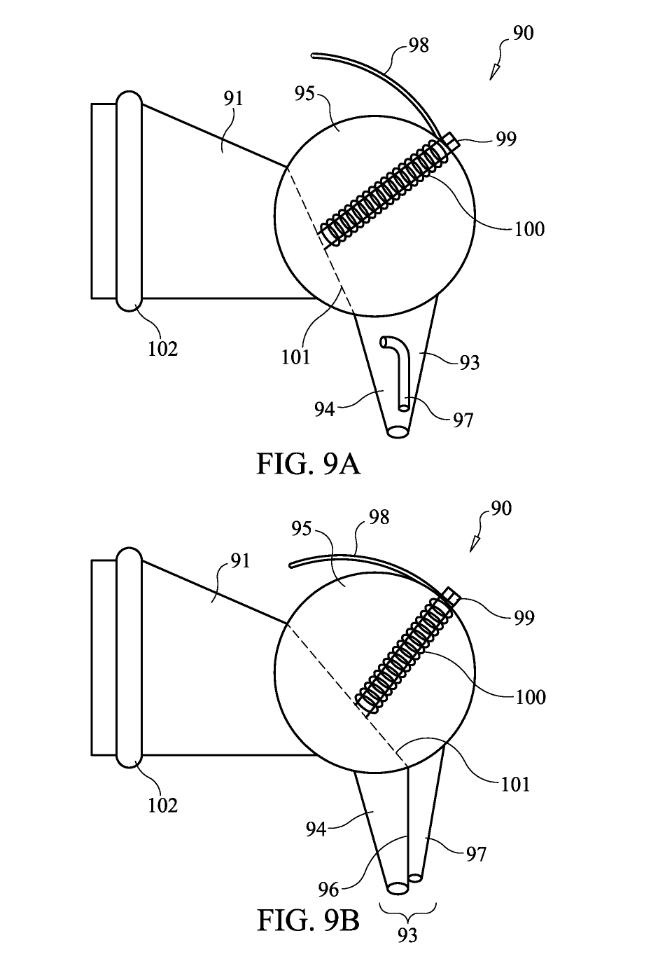

FIGS. 9a and 9b show one embodiment of a nozzle, spout, or spigot 90 for dispensing condiments or other viscous fluids. The spout 90 includes a cylindrical portion 91 with an end that fits into an interior of the threaded spout 2 of the bulk condiment bag 1. The section 91 also preferably includes a rotational locking ring 102 that has threads (not shown) in its interior that mate with the exterior threads 16 of the threaded spout 2 of the condiment bag 1. In other embodiments, a clamp could be used to secure the condiment bag 1 to the spout 90.

The section 91 is connected to a hollow ball shaped section 95, which exits into a nozzle section 93. The hollow ball shaped section 95 is easier to grasp than the valves used in the prior art. The nozzle section 93 preferably includes both a dispensing portion 94 for dispensing condiment into a condiment container, and an outlet 97. In some embodiments, as shown in FIG. 9b, the nozzle section 93 is separated into the dispensing section 94 and the air outlet 97 with a wall 96 formed in between. In other embodiments, for example the embodiment shown in FIG. 9a, the air outlet is preferably curved and does not extend all the way into the ball section 95, so the condiment does not clog the air outlet 97. In addition, the air outlet portion 97 of the nozzle 93 is shorter than the dispensing section 94. In one preferred embodiment, for example, the air outlet portion 97 of the nozzle 93 is preferably approximately ¼ to ½ inch shorter than the dispensing section. In other embodiments, as shown in FIG. 9a, the air outlet 97 is placed outside the dispensing section 94, and curved to let the air out of the nozzle section 93. The air outlet 97 is preferably a tube that is shorter than the dispensing section 94, so the air outlet 97 does not contact the condiment. The air outlet 97 also preferably has at least one hole for release of the air. Curving the air outlet 97 also keeps the spout 90 from being pushed too far into the condiment container 92 when the spout 90 is in use.

A large lever 98 is connected to a pin 99 preferably with a spring 100 surrounding it, which traverses the inside of the hollow ball shaped section 95. The pin 99 is connected to a door 101. Unlike the valve 10 in the prior art, which merely uses a rigid plastic pin 19 to push a piece of flexible plastic 17 out of the way to permit flow through the valve 10, the spring 100 and pin 99 allow fine control of the door 101. The spring 100 permits a variety of tensions to better control the flow of the condiment. In addition, the spring 100 and pin 99 mechanism does not require as much force from the user to activate as the plastic lever 12 in the prior art valve 10. The door 101 traverses the space that connects the cylindrical portion 91 to the ball-shaped section 95, and blocks passage of the condiment from section 91 into the ball-shaped section 95 when the lever 98 is not being pushed, as shown in FIG. 9a. When the lever 98 is pushed, spring 100 retracts, and the pin 99 moves the door 101 so that it is no longer blocking the passage of the condiment from the cylindrical section 91 to the ball shaped section 95, as shown in FIG. 9b. The condiment can now travel into the dispensing section 94 and into the condiment container. Release of the lever 98 extends the spring 100 back into its original position, which also places the door 101 back into its original position.

In one preferred embodiment, the key 85, 266 may be hung around a neck 91 of the spout 90, for example using a chain or other material to hang the key 85, 266. In other embodiments, the key could be reversibly attached to the spout by clipping it to the spout or, if both the spout and the key are magnetic, attached magnetically. Since the key is connected to the refilling spout, it is always available when the user wants to refill the condiment container. The key 85, 266 may be any key that can remove a portion of the plug mechanism of a condiment container, for example the plug mechanisms described in FIGS. 7a through 7d and 8a through 8i, to prepare the condiment container for refilling. In addition, the key 85, 266 could alternatively be affixed to the prior art valve 10. In some embodiments, since the key is magnetic, the removable portion of the plug mechanism and the key would remain together (and connected to the spout) during the refilling process. In addition, when the removable portion is removed, it would continue to be attracted to the magnetic turnkey, and the turnkey with the cap would remain on the spout during refilling. In other embodiments, the removable portion of the plug mechanism and the key 85, 266 could be kept together merely by keeping the key in the keyhole of the removable portion. These embodiments would eliminate the possibility that the user would misplace the turnkey or cap during the refilling process.

The spouts discussed herein may be made from any food grade material including, but not limited to, aluminum, stainless steel, or soft rubber.

Although the connection between the spouts and the condiment bag discussed with reference to the spout embodiments above utilize threads on the condiment bag and the spout, other mechanisms for connection between the spout and the bulk condiment bag could also be used. For example, a double clamp, such as one used for Grolsch® beer bottles, could be used. The threads on the spout could still be utilized, but instead of a locking ring, the double clamp would clamp and seal the connecting spout to the spout of the bulk condiment bag.

While condiment containers with plugs, as discussed herein, could be used in combination with the spouts discussed herein, in other embodiments, the condiment containers could be filled using industrial grade condiment dispensers to dispense condiment into the condiment bottles from the bottom. These embodiments retain the freshness of the condiment, since only fresh condiment is being added, and it is being added to the bottom of the condiment container.

While the refilling methods and devices are described herein as primarily for condiments, they could also be used for other foods. For example, methods of refilling a container from the bottom of the container would be particularly useful on a line in a restaurant kitchen. Typically, kitchens include a number of containers, each containing a different garnish or food item. As an example, a restaurant kitchen may include tomatoes, shredded lettuce, sour cream, and salsa. Often, cooks and other kitchen staff do not rotate these containers. As a result, new food items are put on top of old food items. This may lead to the loss of product, or the potential for serving customers spoiled food.

If the cooks and kitchen staff instead always filled the line containers from the bottom, the oldest foodstuff would be used first, and it would be much less likely that the food would go bad.

As an example, some restaurant kitchens use 6×6 inch plastic or glass square containers. One could design the containers so that the whole bottom comes off, and refill the container with more of the same food from the bottom would be possible.

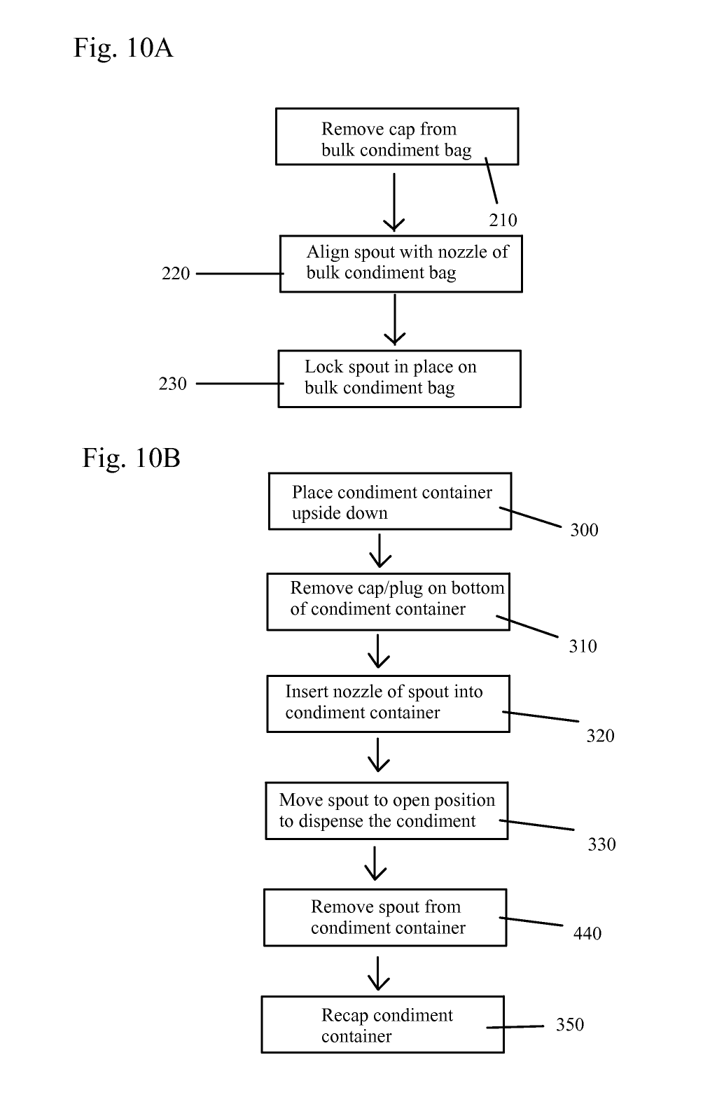

In a method of refilling condiment containers shown in FIGS. 10a and 10b, the bulk condiment bag is first attached to a valve or spout. The valve or spout could be any spout disclosed herein, including the prior art Vol-Pak™ valve and any of the embodiments of the spouts described herein. The cap is removed from the Vol-Pak™ bag in step 210. The spout is then aligned with the neck of the condiment bag in step 220. In embodiments with clamps on the spout, the clamps are aligned with the furthest thread on the condiment bag neck in this step. In embodiments with a locking ring, the locking ring threads are aligned with the threads on the condiment bag spout. The spout is then locked in place on the bulk condiment bag in step 230. In one embodiment, the spout fits into the interior of the spout 2 of a bulk condiment bag and the outer clamps of the spout are pressed down by pinching the neck of the spout in this step. In embodiments with clamps on the spout, the clamps are then released and pushed down to lock and seal the spout to the bulk condiment bag in this step. In another embodiment, a spout fits into the interior of the spout 2 of a bulk condiment bag and the threads of a locking ring on the spout interconnect with the threads on the exterior of the condiment bag spout 2.

The condiment containers are then preferably refilled with the condiment in the bulk condiment bag. The condiment containers are preferably collected and placed in a rack upside down for condiments to settle in step 300. As an example using the condiment containers from FIGS. 7a through 7b and FIGS. 8a through 8h, the conduit is made accessible using a magnetic-turn key to remove the tamper-proof cap located on the base of the condiment container in step 310. In one preferred embodiment, the spout being used has the magnetic-turn key hanging from it, so it is readily available for use. During this step, the user inserts the key and rotates it a quarter turn. The cap at the base of the condiment container is also magnetic and can therefore be removed from the condiment container. Because the cap is magnetic, it will remain on the magnetic key until the container is resealed.

The bulk condiment bag is then used to refill the condiment container by inserting the nozzle on the spout into the bottom of the condiment container in step 320. In the embodiment shown in FIGS. 7a through 7d and FIGS. 8a through 8i, the nozzle on the spout is inserted into the conduit at the base of the condiment container, puncturing the diaphragm in this step. The spout then allows dispersal of the condiment from the condiment bag into the condiment container in step 330. In some spout embodiments, this step is accomplished by pushing a lever on the face of the spout to raise or retract a door and dispense condiment from the bulk condiment bag to the bottom of the condiment container. The nozzle of the spout is removed from the condiment container in step 440. The condiment container is resealed in step 350. In embodiments using a magnetic turnkey, the condiment container is resealed by turning the key in the other direction and removing the key from the magnetic cap at the base of the condiment container in this step. Steps 210-230 can be performed in reverse to remove the spout from the bulk condiment bag.

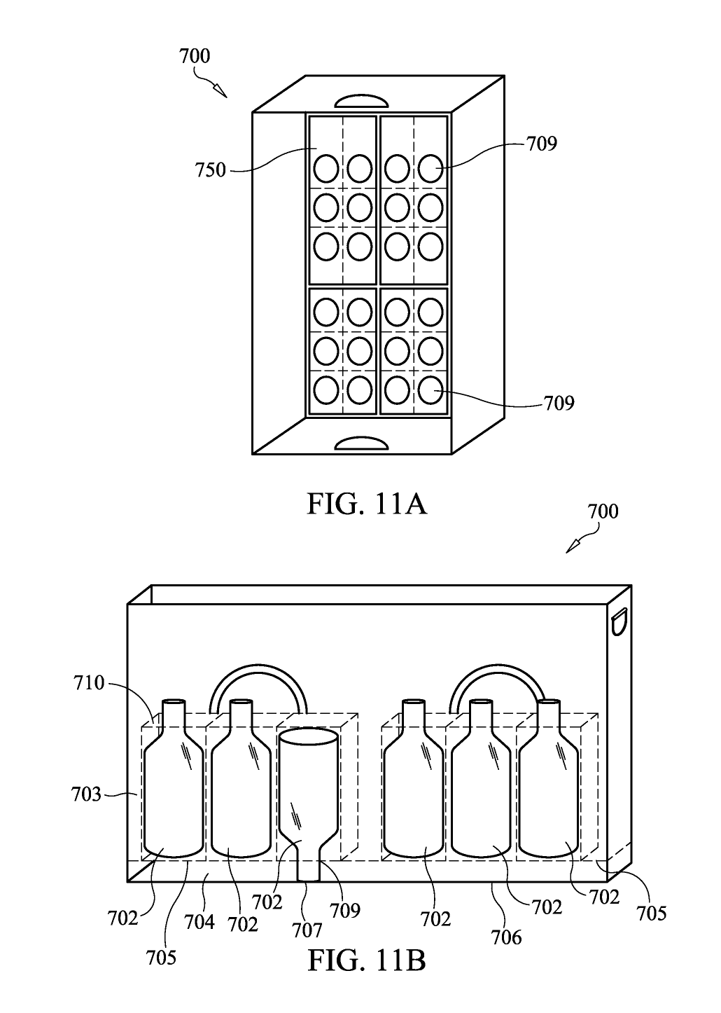

FIGS. 11a and 11b shows an embodiment of a crate 700 that holds the condiment containers 702 upside down to permit settling at the top of the container. The crate is preferably made of any durable material such as wood or plastic. In preferred embodiments, durable plastic is used so that the crate can be easily washed in the dishwasher or by hand. The crate 700 preferably holds multiple condiment containers 702.

The crate 700 includes vertical sections 710; each vertical section 710 preferably holds a single condiment container 702. The crate 700 preferably includes two horizontal sections 703 and 704, separated by the internal bottom 705 of the crate 700. Each vertical section 710 of the internal bottom 705 includes a hole 709 in which the capped portion 707 of the condiment container 702 fits. A second bottom 706 forms the actual bottom of the crate 700. The cap section 704 formed between the internal bottom 705 and the second bottom 706 has a height that fits the capped portions 707 of the condiment containers 702. As shown in FIG. 11b, the condiment containers 702 can be placed upright or upside down in the crate 700, depending upon whether or not the user wants the condiment to settle towards the top of the condiment container 702 for refilling. While a crate 700 that holds 750 four six packs of condiment containers 702 is shown in FIG. 11a, the crate 700 may hold any number of containers 702, including, but not limited to four containers, eight containers, twelve containers, twenty four containers, or any multiple of two containers, within the spirit of the invention. In addition to being used for storage, the crate shown in FIGS. 11a and 11b could be used to hold the condiment containers upside down during the method of FIGS. 10a and 10b.

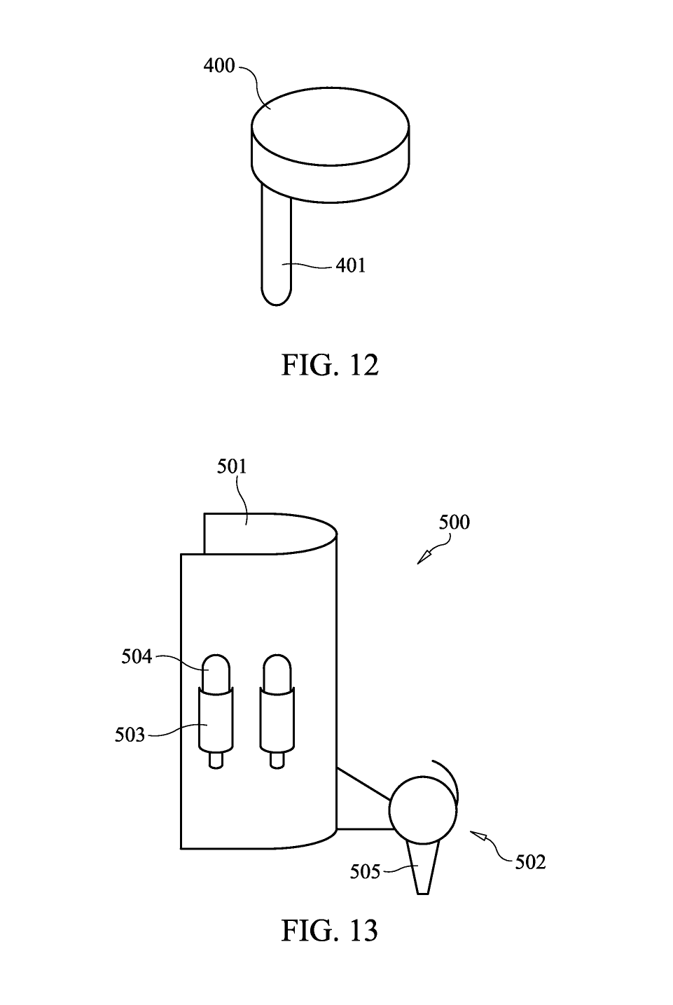

One problem with keeping ketchup and other condiments in restaurants sanitary and fresh is that customers often put their knives (after they have used them on their food or even licked them) into the ketchup bottle to try to release the ketchup. This contaminates the ketchup, and the serving staff has no way of knowing that this has been done in a particular ketchup bottle. To alleviate this problem, in one preferred embodiment shown in FIG. 12, a cap 400 on a condiment container includes an extension 401 attached to the interior of the cap 400. The extension 401 is preferably shaped like a spatula/knife. The extension 401 can be used to scrape the ketchup from the sides of the condiment container. The extension also preferably creates an air pocket to help the condiment flow. The cap also preferably has a flip top, so that the customer/user can alternatively dispense the condiment in the normal manner.

Other embodiments include mounts for the existing bulk condiment bags. FIG. 13 shows one embodiment of a wall mount 500 for a bulk condiment bag. The wall mount 500 is preferably screwed into the wall with two or more fasteners, preferably screws. The wall mount 500 is preferably mounted in a vertical position, so that the spout portion 502 is at the bottom of the wall mount 500 and the nozzle 505 of the spout 502 points down.

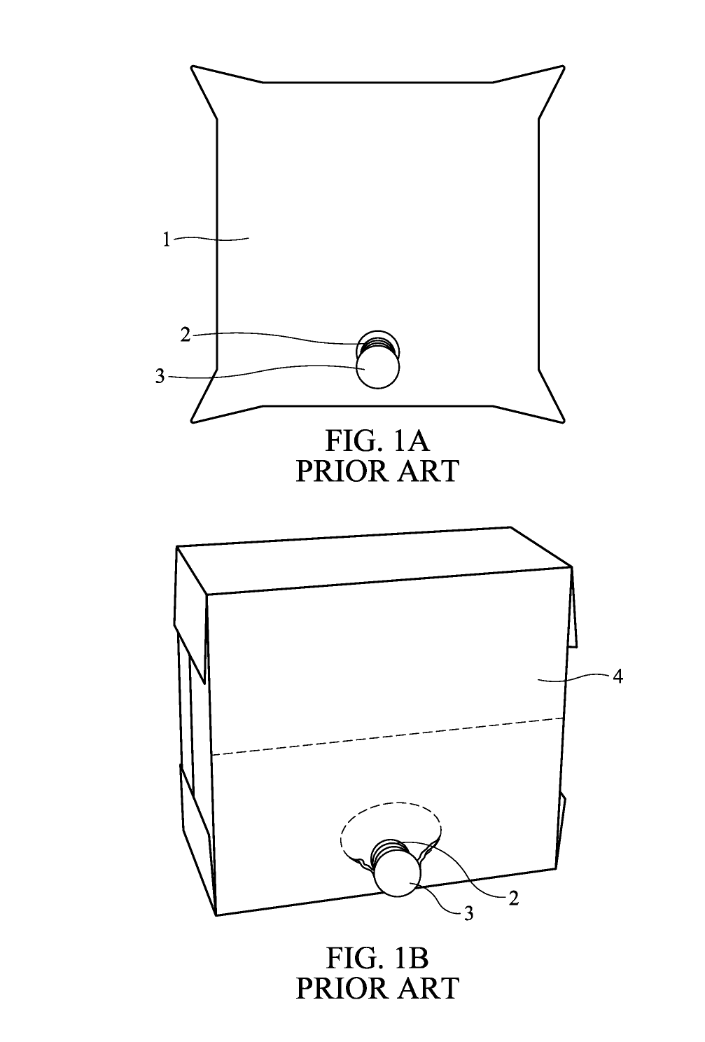

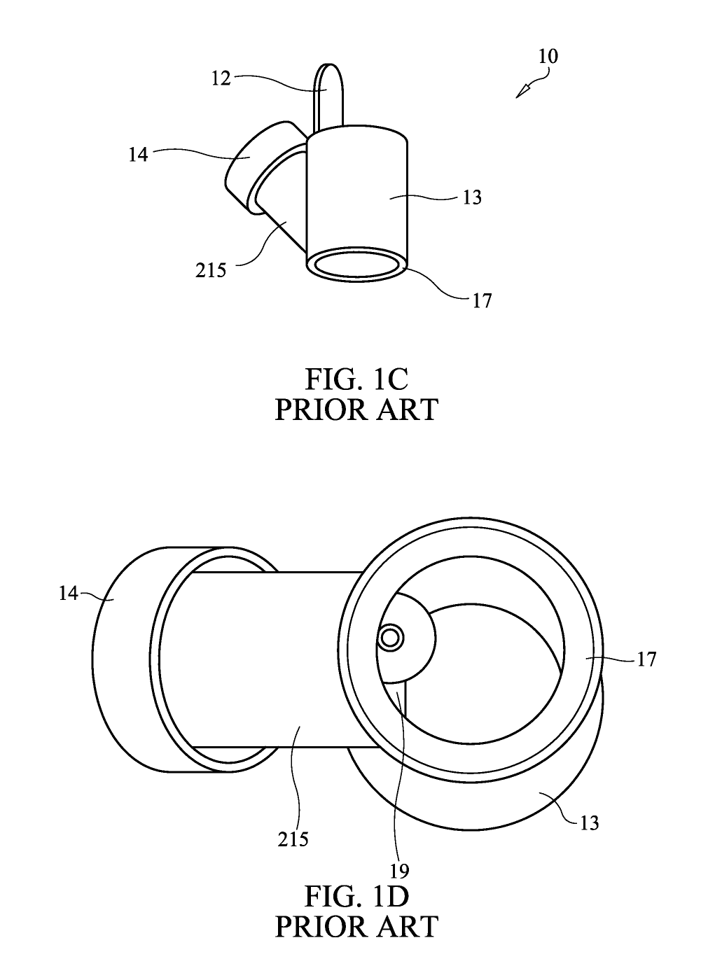

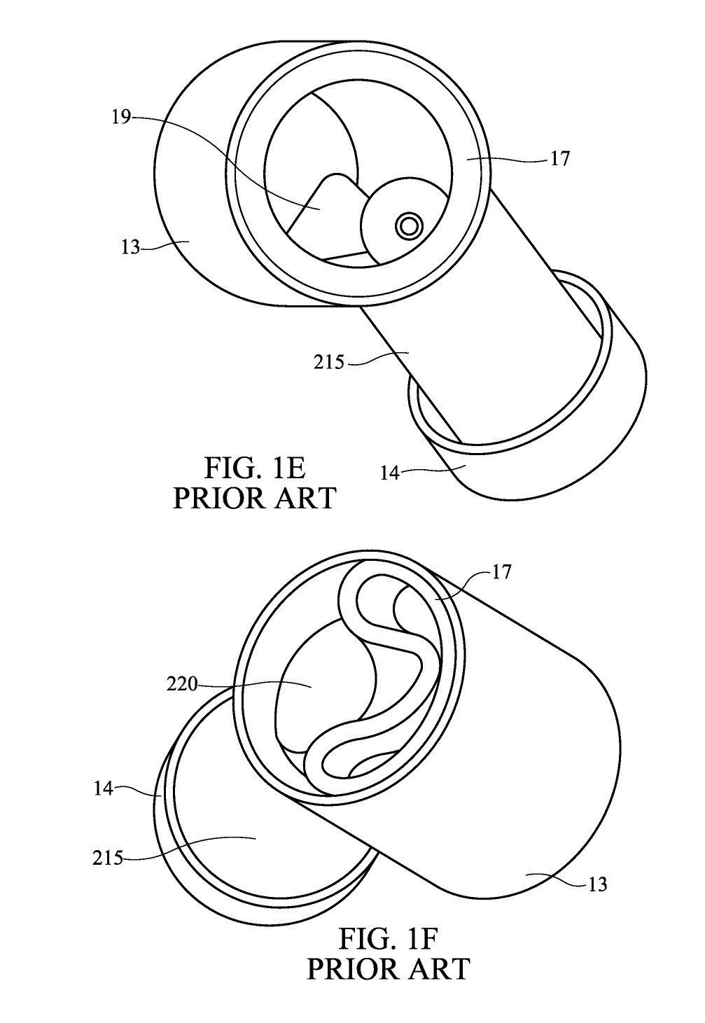

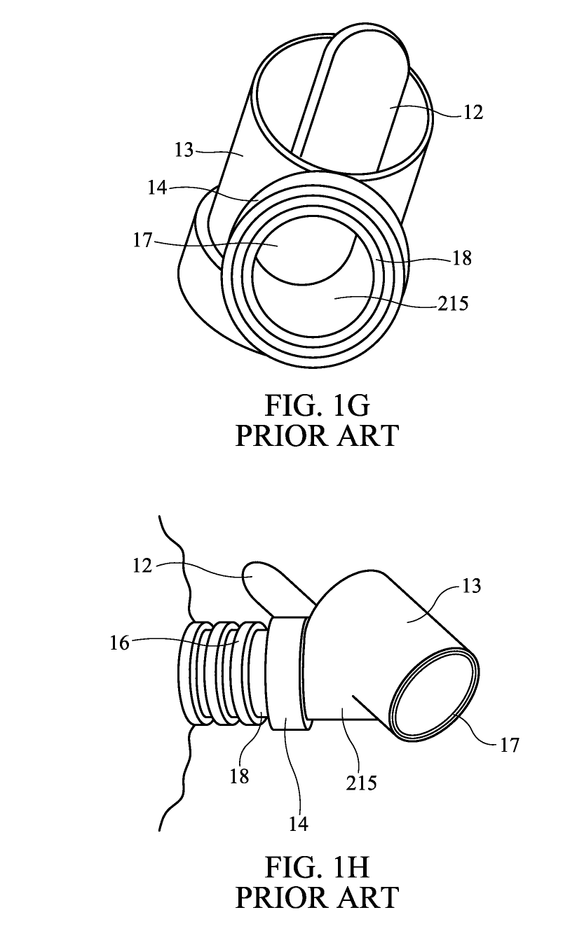

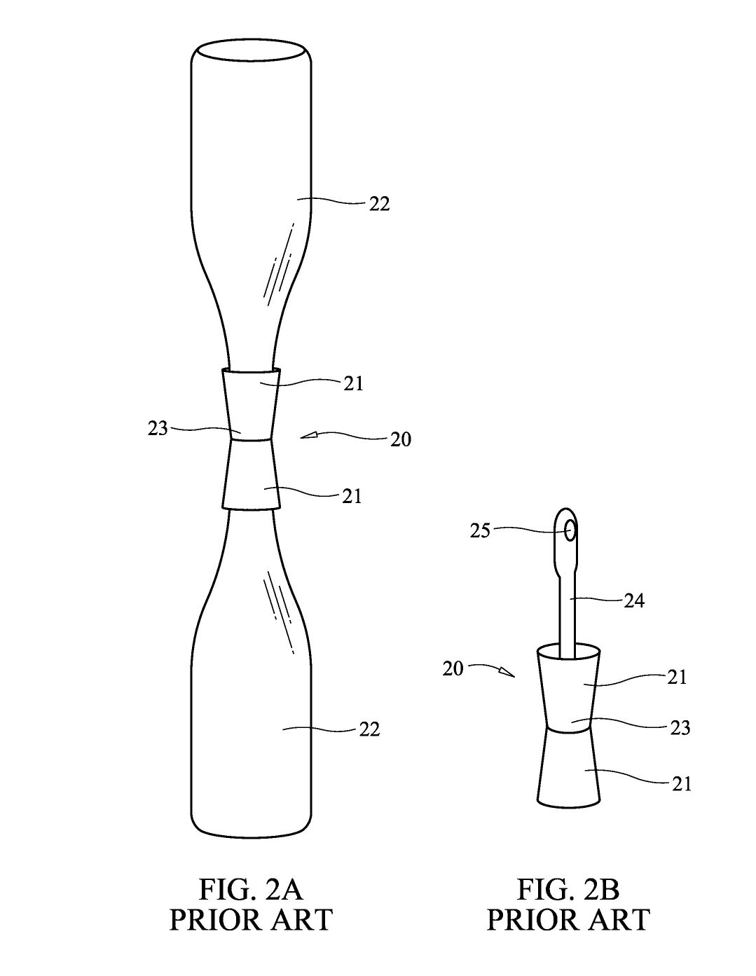

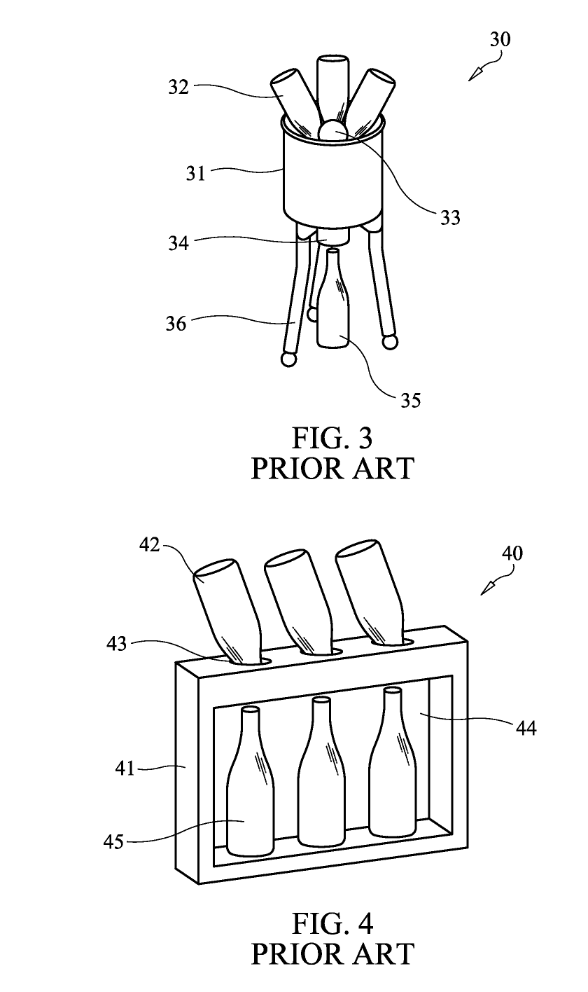

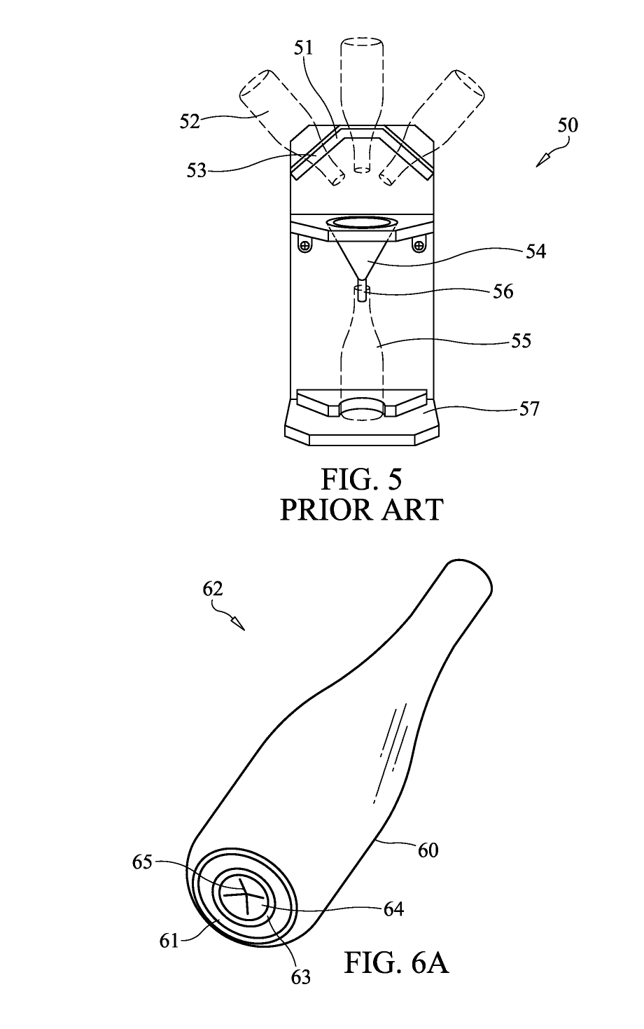

The wall mount 500 includes a sleeve 501 for placing the bulk condiment bag into. The sleeve 501 may be shaped to fit the bulk condiment bag only, or be shaped to fit the entire box into which the condiment bag is usually distributed. The plastic threaded spigot 2 of the bulk condiment bag 1 (see FIG. 1a) is preferably connected to a spout 502 that dispenses the condiment from the bag 1. The spout 502 could be any spigot disclosed herein, including, but not limited to, a Vol-pak™ valve or any of the embodiments discussed in FIGS. 9a through 9b. The sleeve 501 may also optionally have smaller sleeves 503, in which condiment containers 504 may be placed upside down to settle the condiment to the top of the container to prepare them for refilling. Once the condiment has settled, the condiment containers can be refilled at the spout 502. One advantage of the wall mount 500 is that, because it can be mounted on the wall, it does not take up much space, for example in a restaurant kitchen. It also eliminates the need to connect a bulk condiment bag to a spout, or to maneuver the bulk condiment bag, which is heavy, into the restaurant dining room for filling. The wall mount 500 also permits refilling of condiment bottles on the fly, during a meal service, where it would otherwise be difficult and time-consuming to do so. In other embodiments, the spouts and/or the condiment filling system could be used in combination with existing table mounts.

In another preferred embodiment, the condiment containers could be manufactured with an embossed logo for the restaurant in which the condiment containers would be used. In yet another embodiment, the condiment containers could be coded so that they would be recyclable and the user would obtain a return fee (e.g.—5 cent return fee in New York State) if they returned the bottles to a recycling facility. In another embodiment, condiment containers being used in restaurants could include a barcode. Instead of throwing away the bottles when they are no longer of use to the restaurant, the bottles with the barcodes could be returned for a refund. This would encourage restaurants to return the bottles for recycling.

In other preferred embodiments, the caps at the tops of the condiment containers could be made of aluminum, to make them more durable during cleaning and prevent rust. Alternatively, the caps could use double clamps, similar to a Grolsch-type double clamp used for beer. The caps could be made of ceramic, glass, food grade plastic, or any other type of material that is easy to manufacture and to seal. In some embodiments, the cap connected to the clamp contains two pieces. The first piece is connected to the clamp and may be made of ceramic or glass. The second piece fits on the interior bottom portion of the first piece and is preferably made of plastic to create a good seal. The plastic cap portion is removable and easy to clean. In some embodiments, the caps include a flip-top.

While the spouts and condiment containers discussed herein are discussed primarily in use together, either could also be used separately. For example, the spouts could be used with the conventional Vol-Pak™ bags to dispense condiments in the conventional manner As another example, the condiment containers could be used with the traditional Vol-Pak™ valve to dispense condiments into the bottom of the condiment containers.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of dispensing a condiment from a condiment storage container into a condiment dispensing container, comprising the steps of:
connecting a spout with an open position and a closed position to the condiment storage container;
connecting the spout to an opening in a bottom of the condiment dispensing container; and
activating the spout to dispense the condiment from the condiment storage container into the bottom of the condiment dispensing container through a conduit;
wherein the spout is separate from the condiment dispensing container, as well as the condiment storage container.

2. The method of claim 1, wherein the condiment dispensing container includes a diaphragm shaped to permit entry of the condiment into the condiment dispensing container but prohibit exit of the condiment out of the condiment dispensing container.

3. The method of claim 1, wherein the step of activating the spout comprises the substep of moving the spout from the closed position to the open position.

4. The method of claim 3, wherein the activating step is performed manually by a user.

5. The method of claim 1, wherein the bottom of the condiment dispensing container comprises a plug mechanism comprising:
a) a malleable diaphragm comprising a donut-shaped portion that forms a seal in an interior of the condiment dispensing container and a diaphragm bottom section comprising at least two slitted openings, wherein the donut-shaped portion faces towards a top of the condiment dispensing container and the diaphragm bottom section forms a base of the diaphragm within the condiment dispensing container;
b) a conduit comprising a shoulder and a main body, wherein the main body comprises interior threads and the shoulder is shaped to fit into an interior of the diaphragm through the donut-shaped portion such that the main body extends towards a bottom exterior of the condiment dispensing container; and
c) a cap comprising a cap main body comprising an outer portion comprising a key mating portion and exterior threads that mate with the interior threads of the conduit;
wherein the diaphragm and the shoulder of the conduit have a diameter sized to fit into an interior portion of the bottom of the condiment dispensing container;
wherein the cap has a diameter sized to fit into an interior portion of the conduit such that the conduit is flush with the bottom of the condiment dispensing container or recessed into the bottom of the condiment dispensing container.

6. The method of claim 5, further comprising the step of removing the cap from the bottom of the condiment dispensing container.

7. The method of claim 6, wherein the key mating portion in the cap comprises indentations that mate with corresponding protrusions in a key used to remove the cap.

8. The method of claim 7, wherein the cap and the key are magnetic.

9. The method of claim 1, wherein the condiment dispensing container comprises a stopper that fits into a top of the condiment dispensing container.

10. A refillable condiment dispensing container, wherein a bottom of the condiment dispensing container comprises a plug mechanism comprising:
a) a malleable diaphragm comprising a donut-shaped portion that forms a seal in an interior of the condiment dispensing container and a diaphragm bottom section comprising at least two slitted openings, wherein the donut-shaped portion faces towards a top of the condiment dispensing container and the diaphragm bottom section forms a base of the diaphragm within the condiment dispensing container;
b) a conduit comprising a shoulder and a main body, wherein the main body comprises interior threads and the shoulder is shaped to fit into an interior of the diaphragm through the donut-shaped portion such that the main body extends towards a bottom exterior of the condiment dispensing container; and
c) a cap comprising a cap main body comprising an outer portion comprising a key mating portion and exterior threads that mate with the interior threads of the conduit;
wherein the diaphragm and the shoulder of the conduit have a diameter sized to fit into an interior portion of the bottom of the condiment dispensing container;
wherein the cap has a diameter sized to fit into an interior portion of the conduit such that the conduit is flush with the bottom of the condiment dispensing container or recessed into the bottom of the condiment dispensing container.

11. The refillable condiment dispensing container of claim 10, wherein the key mating portion in the cap comprises indentations that mate with corresponding protrusions in a key such that the cap is removable from the condiment dispensing container.

12. The refillable condiment dispensing container of claim 11, wherein the cap and the key are magnetic.

13. The refillable condiment dispensing container of claim 10, further comprising a stopper that fits into a top of the condiment dispensing container.

14. A spout for dispensing a condiment into a condiment container, comprising:
a nozzle section that fits into the condiment container;
a receiving section comprising an end that receives fresh condiment from a fresh condiment source; and
a control section connecting the nozzle section to the receiving section, comprising an activating mechanism for controlling flow of the condiment from the receiving section into the nozzle section;
wherein the activating mechanism comprises an activator, a pin, and a spring that control a door that blocks flow of the condiment from the receiving section into the nozzle section when the activator is not activated by a user;
wherein, when the activator is acted upon by the user, the pin and spring move the door to a position that permits flow of the condiment from the receiving section, through the control section and into the nozzle section.

15. The spout of claim 14, wherein the nozzle section of the spout is designed to fit into a bottom of the condiment container.

16. The spout of claim 14, further comprising an air release section.

17. A condiment refilling system, comprising:
a) a plurality of condiment dispensing containers, wherein each condiment dispensing container comprises a plug mechanism at a bottom of the conduit container into which fresh condiment can be dispensed, wherein the plug mechanism comprises a removable cap with a key mating portion;
b) a spout comprising a nozzle section that fits into a condiment dispensing container, a receiving section comprising an end that receives fresh condiment from a fresh condiment source, and a control section connecting the nozzle section to the receiving section, wherein the control section comprises an activating mechanism for controlling flow of the condiment from the receiving section into the nozzle section; and
c) a key that mates with the key mating portion of the removable cap to remove the cap from the condiment container; wherein the key is attached to the spout.

18. The system of claim 17, wherein the key mating portion of the removable cap is magnetic and the key is a magnetic turnkey.

19. The system of claim 17, wherein the key is attached to the spout by hanging the key around one of the sections of the spout.

20. The system of claim 17, wherein the plug mechanism comprises:
a) a malleable diaphragm comprising a donut-shaped portion that forms a seal in an interior of the condiment dispensing container and a diaphragm bottom section comprising at least two slitted openings, wherein the donut-shaped portion faces towards a top of the condiment dispensing container and the diaphragm bottom section forms a base of the diaphragm within the condiment dispensing container;
b) a conduit comprising a shoulder and a main body, wherein the main body comprises interior threads and the shoulder is shaped to fit into an interior of the diaphragm through the donut-shaped portion such that the main body extends towards a bottom exterior of the condiment dispensing container; and
c) a cap comprising a cap main body comprising an outer portion comprising a key mating portion and exterior threads that mate with the interior threads of the conduit;
wherein the diaphragm and the shoulder of the conduit have a diameter sized to fit into an interior portion of the bottom of the condiment dispensing container;
wherein the cap has a diameter sized to fit into an interior portion of the conduit such that the conduit is flush with the bottom of the condiment dispensing container or recessed into the bottom of the condiment dispensing container.
